(19) United States
(12) Patent Application Publication
(10) Pub. No.: US 2017/0247518 A1
(43) Pub. Date: Aug. 31, 2017

(54) THERMOPLASTIC PREPREG

(71) Applicant: Swancor Ind. Co., Ltd., Nantou County (TW)

(72) Inventors: Kok-Sheng Tan, Nantou County (TW); Chen-Han Chien, Nantou County (TW); Yu-Tsan Tseng, Nantou County (TW)

(21) Appl. No.: 15/052,901

(22) Filed: Feb. 25, 2016

(51) Int. Cl. C08J 5/24

(52) U.S. Cl. CPC C08J 5/24; C08J 2363/00; C08J 2325/06

(57) ABSTRACT

A thermoplastic prepreg includes a latent resin and a fiber, wherein the latent resin at least includes a resin and a latent hardener or an initiator. The latent resin includes an in-situ polymerization formulation, and the latent resin has a viscosity of 500,000-70,000,000 cps at 25° C. The thermoplastic prepreg is suitable for various wet lay-up processes.

### BACKGROUND OF THE INVENTION

Field of the Invention

The present invention generally relates to a prepreg for manufacturing composite products, in particular, to a thermoplastic prepreg for wet lay-up process.

Description of Related Art

The prepreg is the common term for a reinforcing fabric which has been impregnated with a resin system. The process of prepreg may be used to control RC (resin content) of a composite product such that a low RC composite can be accomplished. For example, U.S. Pat. No. 4,024,305 describes a prepreg sheet made from epoxy resin.

Recently, the need of recycling has become desired, and thus U.S. Pat. No. 4,445,951 describes a reinforcing filaments enclosed in a matrix of a thermoplastic polymer with solvent. However, there is an issue about insufficient impregnation in the thermoplastic prepreg, and it has to perform a post-molding at high temperature.

As to commercially available thermoplastic prepreg, it is required to be molded at high temperature and high pressure in order to solve the insufficient impregnation. Nevertheless, this kind of thermoplastic prepreg cannot produce composite product with complex structure.

### SUMMARY OF THE INVENTION

The present invention provides a thermoplastic prepreg including a latent resin and a fiber, wherein the latent resin at least includes a resin and a latent hardener/initiator. The latent resin includes an in-situ polymerization formulation, and the latent resin has a viscosity of 500,000-70,000,000 cps at 25° C.

In an embodiment of the invention, the in-situ polymerization formulation includes a reactive polymerized formulation, or a radical polymerized formulation.

In an embodiment of the invention, the resin in the reactive polymerized formulation comprises thermoplastic epoxy resin, polyurethane (PU) or polyurea.

In an embodiment of the invention, the reactive polymerized formulation includes a catalyst, an amine chain extender and an epoxy resin with an epoxide equivalent weight (EEW) of 250-650 g/mol, and the epoxy resin and the amine chain extender are prepared in a mole ratio of 0.9:1 to 1:0.9.

In an embodiment of the invention, the amine chain extender is a dual active hydrogen amine chain extender.

In an embodiment of the invention, the dual active hydrogen amine chain extender is selected from at least one of compounds represented by formula (1) to formula (3) below:

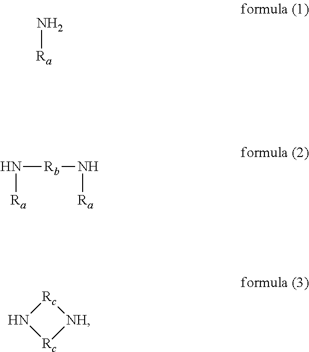

wherein Rₐ is a C1 to C20 alkyl group, a C5 to C12 cycloalkyl group, a C6 to C18 aryl group, or a C6 to C20 aralkyl group; R_{b} is a C1 to C20 alkyl group or a C5 to C12 aryl group; and R_{c} is a C1 to C20 alkyl group.

In an embodiment of the invention, the amine chain extender includes nitroaniline.

In an embodiment of the invention, the epoxy resin includes a bifunctional epoxy resin.

In an embodiment of the invention, the catalyst includes a molecule having phenol, and a weight ratio of the catalyst to the thermoplastic prepreg is between 0 and 5%.

In an embodiment of the invention, the latent resin has the viscosity of 8,000,000-70,000,000 cps at 25° C.

In another embodiment of the invention, the reactive polymerized formulation includes a catalyst, a bisphenol chain extender and an epoxy resin with an epoxide equivalent weight (EEW) of 250-650 g/mol, and the epoxy resin and the bisphenol chain extender are prepared in a mole ratio of 0.9:1 to 1:0.9.

In another embodiment of the invention, the bisphenol chain extender includes bisphenol A (BPA), bisphenol F (BPF), bisphenol Z (BPZ), fluorene-9-biphenol, or tetrabromobisphenol A (TBBPA).

In another embodiment of the invention, the epoxy resin includes a bifunctional epoxy resin.

In another embodiment of the invention, the catalyst may be Lewis base, and a weight ratio of the catalyst to the thermoplastic prepreg is 0.1%-5%.

In another embodiment of the invention, the latent resin has the viscosity of 8,000,000-70,000,000 cps at 25° C.

In yet another embodiment of the invention, the resin in the radical polymerized formulation comprises polystyrene (PS), polymethylmethacrylate (PMMA), poly(methacrylic acid) (PMAA), polyvinyl acetate (PVAc), or copolymer thereof.

In yet another embodiment of the invention, the radical polymerized formulation includes a monomer, a polymer and an initiator, the monomer includes an acrylic or vinyl monomer having a boiling point higher than 60° C., the polymer includes PS, PMMA, PMAA, PVAc or copolymer thereof. The initiator is peroxide having a reactive temperature higher than 60° C.

In yet another embodiment of the invention, the acrylic or vinyl monomer is one selected from the group consisting of styrene, methylmethacrylate, methacrylic acid, and vinyl acetate.

In yet another embodiment of the invention, the initiator comprises tertbutyl hydroperoxide, cumene hydroperoxide (CHP), or benzoyl peroxide (BPO).

In yet another embodiment of the invention, a weight ratio of the initiator to the monomer is 0.1%-2%, and a weight ratio of the monomer to the polymer ranges between 10:1 and 10:50.

In yet another embodiment of the invention, the latent resin has the viscosity of 500,000-1,000,000 cps at 25° C.

In an embodiment of the invention, the thermoplastic prepreg further includes a filler for improving at least one of flame-retardance, UV resistance, and yellowing resistance.

Based on the above, in the thermoplastic prepreg according to the present invention, the latent resin has a viscosity of 500,000-70,000,000 cps at 25° C., and thus the thermoplastic prepreg is able to manufacture a composite product by various wet lay-up processes. Therefore, the thermoplastic prepreg is suitable for manufacturing the composite product with complex structures.

To make the above features of the invention more comprehensible, several embodiments are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a process flow of composite product according to an embodiment of the present invention.

FIG. 2 is a diagram illustrating the variations in viscosity at different temperature of Example 1.

FIG. 3 is a diagram illustrating the variations in viscosity at different temperature of Example 2.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In one exemplary embodiment of the present invention, a thermoplastic prepreg is introduced that includes a latent resin and a fiber, wherein the latent resin at least includes a (raw) resin, and a latent hardener or an initiator. The latent resin includes an in-situ polymerization formulation such as a reactive polymerized formulation or a radical polymerized formulation. The so-called “latent resin” means that a resin is stable at low temperature (i.e. 60° C. or less) and may be polymerized at high temperature (for example, 80° C.-200° C., depending on resin formulations). In addition, the latent resin in the exemplary embodiment has no solvent and it does not produce small molecule by-product through the in-situ polymerization. The latent resin has a viscosity of 500,000-70,000,000 cps at 25° C., preferably 500,000-65,000,000 cps at 25° C., and more preferably 750,000-59,000,000 cps at 25° C. If the viscosity is less than 500,000 cps, it is not conducive to film formation; if the viscosity is more than 70,000,000 cps, it is hard to stack multi-layer prepregs. The thermoplastic prepreg may be includes a filler for improving at least one of flame-retardance, UV resistance, and yellowing resistance, for example.

In the reactive polymerized formulation, the resin used in the latent resin may be thermoplastic epoxy resin, polyurethane (PU) or polyurea, but it is not limited thereto. In the radical polymerized formulation, the resin used in the latent resin may be polystyrene (PS), polymethylmethacrylate (PMMA), poly(methacrylic acid) (PMAA), polyvinyl acetate (PVAc), or copolymer thereof, but it is not limited thereto.

If the in-situ polymerization formulation is a reactive polymerized formulation, for example, it may include a catalyst, an amine chain extender and an epoxy resin with an epoxide equivalent weight (EEW) of 250-650 g/mol, and the epoxy resin and the amine chain extender can be prepared in a mole ratio of 0.9:1 to 1:0.9. The amine chain extender, for example, is a dual active hydrogen amine chain extender.

The dual active hydrogen amine chain extender is, for example, selected from at least one of compounds represented by formula (1) to formula (3) below:

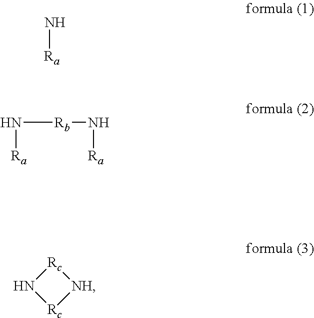

wherein Rₐ is a C1 to C20 alkyl group, a C5 to C12 cycloalkyl group, a C6 to C18 aryl group, or a C6 to C20 aralkyl group; R_{b} is a C1 to C20 alkyl group or a C5 to C12 aryl group; and R_{c} is a C1 to C20 alkyl group.

In one embodiment, the amine chain extender includes nitroaniline or other suitable chain extenders. The epoxy resin, for example, includes a mixture of a bifunctional epoxy resin, but it is not limited thereto. Alternatively, the epoxy resin with an EEW of 250-650 g/mol may be single bifunctional epoxy resin. Moreover, the catalyst may be a molecule having phenol in this embodiment, for instance. A weight ratio of the catalyst to the thermoplastic prepreg is, for example, between 0 and 5%; preferably more than 0 and less than 5%. According to this reactive polymerized formulation, the latent resin, for instance, has a viscosity of 8,000,000-70,000,000 cps at 25° C.; preferably 8,000,000-59,000,000 cps.

In other embodiment, if the in-situ polymerization formulation is a reactive polymerized formulation, for example, it may include a catalyst, a bisphenol chain extender and an epoxy resin with an EEW of 250-650 g/mol, and the epoxy resin and the bisphenol chain extender are prepared in a mole ratio of 0.9:1 to 1:0.9. The bisphenol chain extender includes BPA, BPF, BPZ, fluorene-9-biphenol, or TBBPA, for instance. The epoxy resin with an EEW of 250-650 g/mol may be single resin or a mixture of a bifunctional epoxy resin. The catalyst may be Lewis base in this embodiment, for instance. A weight ratio of the catalyst to the thermoplastic prepreg is, for example, 0.1%-5%. According to this reactive polymerized formulation, the latent resin, for instance, has a viscosity of 8,000,000-70,000,000 cps at 25° C.; preferably 8,000,000-59,000,000 cps.

In yet other embodiment, if the in-situ polymerization formulation is a radical polymerized formulation, for example, it may include a monomer, a polymer and an initiator. The monomer includes an acrylic or vinyl monomer having a boiling point higher than 60° C., for instance. The acrylic or vinyl monomer is one selected from the group consisting of styrene, methylmethacrylate, methacrylic acid, and vinyl acetate, for instance. The polymer includes polystyrene (PS), polymethylmethacrylate (PMMA), poly(methacrylic acid) (PMAA), polyvinyl acetate (PVAc), or copolymer thereof, for instance. The initiator is, for example, a peroxide having a reactive temperature higher than 60° C., and the initiator includes tertbutyl hydroperoxide, cumene hydroperoxide (CHP), or benzoyl peroxide (BPO). A weight ratio of the initiator to the monomer is 0.1%-2%, and a weight ratio of the monomer to the polymer ranges between 10:1 and 10:50, for instance. According to this radical polymerized formulation, the latent resin, for instance, has a viscosity of 500,000-1,000,000 cps at 25° C. The thermoplastic prepreg containing the radical polymerized formulation may be kept below 0° C. such as −18° C.

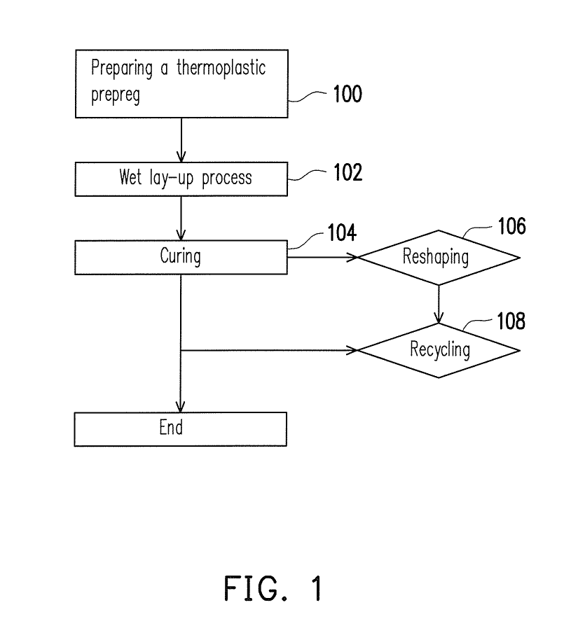

FIG. 1 is a process flow of composite product by using the thermoplastic prepreg in the exemplary embodiment of the present invention.

Referring to FIG. 1, step 100 is performed to prepare a thermoplastic prepreg. The thermoplastic prepreg is manufacture by impregnating fibers with the latent resin at 40° C.-100° C. The latent resin is the same as above embodiments, and thus the detail is not described again. Moreover, in the step 100, it is possible to add fillers into the thermoplastic prepreg for improving at least one of flame-retardance, UV resistance, and yellowing resistance.

Then, step 102 is performed to accomplish a wet lay-up process by using the thermoplastic prepreg. For example, the wet lay-up process may be Autoclave, blow molding, vacuum bag molding, flexible molding, hot press molding, etc.

Then, step 104 is performed to cure the thermoplastic prepreg formed in the step 102, and a composite product may be manufacture. The curing may be performed at high temperature (e.g. 60° C. -180° C.) for 30 minutes to 24 hours, for example.

After the step 104, it is optionally to perform step 106 or step 108. In the step 106, the composite product can be reshaped if necessary. In the step 108, the composite product can be recycled due to the characteristic of the thermoplastic prepreg.

Several experiments are conducted to verify the effects that can be achieved, whereas the scope of protection is not limited to those described hereinafter.

### EXAMPLE 1

Raw material:

Amine chain extender: 3-nitroaniline;

Epoxy resin: BE-188 (EEW=186 g/mol), BE-501 (EEW=475 g/mol) (ChangChun Plastics. Co. Ltd.);

Catalyst: bisphenol A.

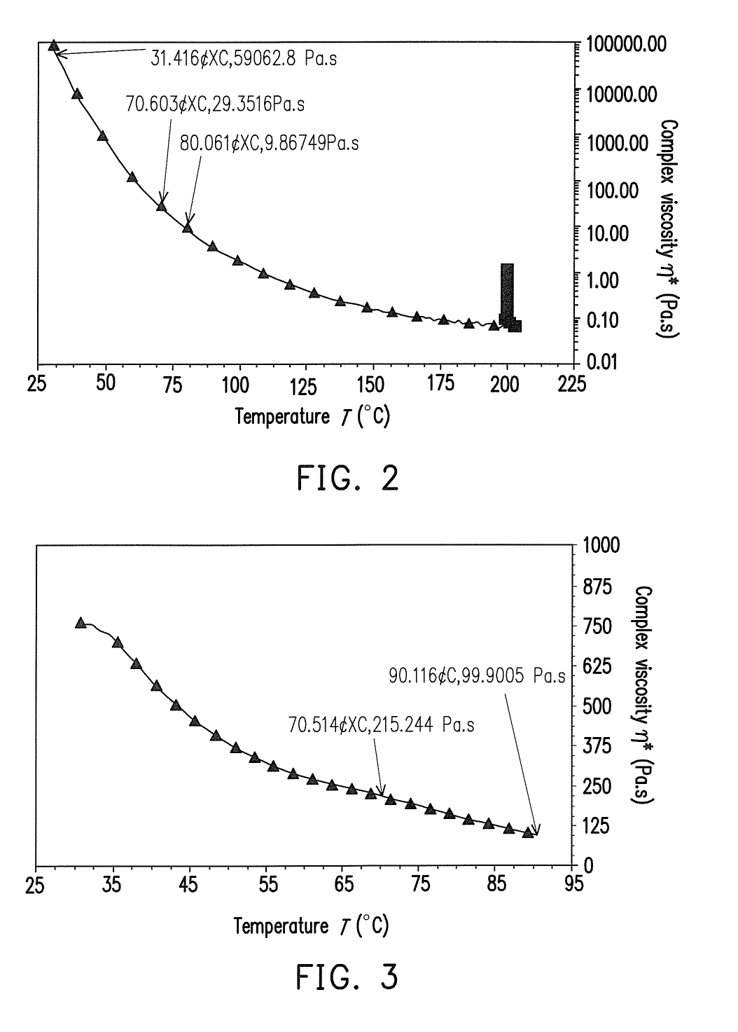

The mixture containing 2.07 g of 3-nitroaniline, 7.5 g of BE-501, 2.5 g of BE-188 and 0.2 g of bisphenol A is stirred at 120° C. for 30 minutes so as to obtain a deep orange clear resin (i.e. latent resin). Thereafter, the viscosity of the obtained resin is measured at different temperature, and the results are illustrated in FIG. 2. The viscosity of the obtained resin is from about 8,000,000 cps to about 70,000,000 cps at room temperature. After the obtained resin is kept for 7 days, its viscosity has no obvious change.

In FIG. 2, it shows that the viscosity is about 59062.8 Pa.s (converted to 59,082,800 cps) at 31.416° C. At 70° C.-80° C., the viscosity is about 1,000 cps-30,000 cps, and thus the latent resin is suitable to form a film. At 120° C., the viscosity is below 1,000 cps, and thus the latent resin is easy to impregnate into carbon fibers.

In addition, after the latent resin of Example 1 is cured at 180° C. for 2 hours, a thermoplastic material (Mw=20,000-25,000) is formed.

### EXAMPLE 2

Raw material:

Monomer: styrene monomer (>99% purity from Sigma-Aldrich);

Polymer: polystyrene powders (Mw=35,000, Purchased from Sigma-Aldrich);

Initiator:CHP(purchased Sigma-Aldrich).

50 g of polystyrene powders is solved in 25 g of styrene monomer added 1 wt % CHP to obtain a mixture. The mixture is stirred by planet stirrer at 40° C. for 10 minutes so as to form a high-viscosity resin (i.e. latent resin). Thereafter, the viscosity of the formed resin is measured at different temperature, and the results are illustrated in FIG. 3. The latent resin can be kept for 7 days at room temperature or kept for one month below 0° C.

In FIG. 3, it shows that the viscosity is about 750,000 cps at room temperature. The viscosity is about 99,000 cps at 90° C., and thus the latent resin is suitable to form a film and impregnate into fibers.

In addition, after the latent resin of Example 2 is cured at 80° C. for 24 hours, a thermoplastic material can be formed.

Preparation 1

3K woven carbon fiber cloth is impregnated by the latent resin of example 1 through hand layup at 80° C. In detail, 50 g of the latent resin of example 1 is preheated at 80° C., a release sheet is put on a hot plate, and the carbon fiber cloth is then put on release surface of the release sheet. After the temperature of the carbon fiber cloth is up to 80° C., the latent resin is applied to the carbon fiber cloth, and then the hand layup is performed with roller. After the carbon fiber is fully impregnated, another release sheet is put thereon and its release surface faces the impregnated carbon fiber. After cooling, a thermoplastic prepreg can be obtained.

Preparation 2

3K woven carbon fiber cloth is impregnated by the latent resin of example 2 through hand layup at 90° C. In detail, 50 g of the latent resin of example 2 is preheated at 90° C., a release sheet is put on a hot plate, and the carbon fiber cloth is then put on release surface of the release sheet. After the temperature of the carbon fiber cloth is up to 90° C., the latent resin is applied to the carbon fiber cloth, and then the hand layup is performed with roller. After the carbon fiber is fully impregnated, another release sheet is put thereon and its release surface faces the impregnated carbon fiber. Thereafter, the release sheets and the impregnated carbon fiber sandwiched by the same are pressed by heat roller in order to ensure that the latent resin is dispersed uniformly. After cooling, a thermoplastic prepreg can be obtained.

Based on the above, according to the present invention, the viscosity of the latent resin in the thermoplastic prepreg can be controlled in specific range, so it can be applied for present wet lay-up process without process adjustment. Since the thermoplastic prepreg can be utilized in the wet lay-up process, the product with complex structure may be accomplished such as continuous hollow tube, multi-directional stacks, or sports goods (e.g. hockey pole, tennis racket, badminton racket and so on). Moreover, it is possible to reshape the composite product made by the thermoplastic prepreg in the present application, and thus it is also easy to repair surface thereof.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thermoplastic prepreg, comprising:
a latent resin and a fiber, wherein the latent resin comprises a resin, and a latent hardener or an initiator,
the latent resin comprises an in-situ polymerization formulation; and
the latent resin has a viscosity of 500,000-70,000,000 cps at 25° C.

2. The thermoplastic prepreg of claim 1, wherein the in-situ polymerization formulation comprises a reactive polymerized formulation or a radical polymerized formulation.

3. The thermoplastic prepreg of claim 2, wherein the resin in the reactive polymerized formulation comprises thermoplastic epoxy resin, polyurethane (PU) or polyurea.

4. The thermoplastic prepreg of claim 2, wherein the reactive polymerized formulation comprises a catalyst, an amine chain extender and an epoxy resin with an epoxide equivalent weight (EEW) of 250-650 g/mol, and the epoxy resin and the amine chain extender are prepared in a mole ratio of 0.9:1 to 1:0.9.

5. The thermoplastic prepreg of claim 4, wherein the amine chain extender is a dual active hydrogen amine chain extender.

6. The thermoplastic prepreg of claim 5, wherein the dual active hydrogen amine chain extender is selected from at least one of compounds represented by formula (1) to formula (3) below: 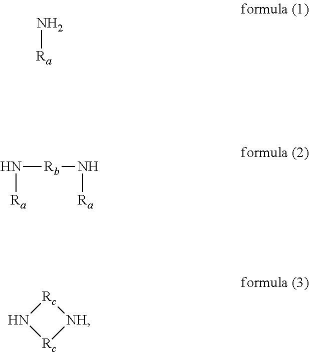
wherein Rₐ is a C1 to C20 alkyl group, a C5 to C12 cycloalkyl group, a C6 to C18 aryl group, or a C6 to C20 aralkyl group; R_{b} is a C1 to C20 alkyl group or a C5 to C12 aryl group; and R_{c} is a C1 to C20 alkyl group.

7. The thermoplastic prepreg of claim 6, wherein the amine chain extender comprises nitroaniline.

8. The thermoplastic prepreg of claim 4, wherein the epoxy resin comprises a bifunctional epoxy resin.

9. The thermoplastic prepreg of claim 4, wherein the catalyst comprises a molecule having phenol, and a weight ratio of the catalyst to the thermoplastic prepreg is between 0 and 5%.

10. The thermoplastic prepreg of claim 4, wherein the latent resin has the viscosity of 8,000,000-70,000,000 cps at 25° C.

11. The thermoplastic prepreg of claim 2, wherein the reactive polymerized formulation comprises a catalyst, a bisphenol chain extender and an epoxy resin with an epoxide equivalent weight (EEW) of 250-650 g/mol, and the epoxy resin and the bisphenol chain extender are prepared in a mole ratio of 0.9:1 to 1:0.9.

12. The thermoplastic prepreg of claim 11, wherein the bisphenol chain extender comprises BPA, BPF, BPZ, fluorene-9-biphenol, or TBBPA.

13. The thermoplastic prepreg of claim 11, wherein the epoxy resin comprises a bifunctional epoxy resin.

14. The thermoplastic prepreg of claim 11, wherein the catalyst comprises Lewis base, and a weight ratio of the catalyst to the thermoplastic prepreg is 0.1%-5%.

15. The thermoplastic prepreg of claim 11, wherein the latent resin has the viscosity of 8,000,000-70,000,000 cps at 25° C.

16. The thermoplastic prepreg of claim 2, wherein the resin in the radical polymerized formulation comprises polystyrene (PS), polymethylmethacrylate (PMMA), poly(methacrylic acid) (PMAA), polyvinyl acetate (PVAc), or copolymer thereof.

17. The thermoplastic prepreg of claim 2, wherein the radical polymerized formulation comprises a monomer, a polymer and the initiator, the monomer comprises an acrylic or vinyl monomer having a boiling point higher than 60° C., the polymer comprises PS, PMMA, PMAA, PVAc or copolymer thereof, and the initiator is a peroxide having a reactive temperature higher than 60° C.

18. The thermoplastic prepreg of claim 17, wherein the acrylic or vinyl monomer is one selected from the group consisting of styrene, methylmethacrylate, methacrylic acid, and vinyl acetate.

19. The thermoplastic prepreg of claim 17, wherein the initiator comprises tertbutyl hydroperoxide, cumene hydroperoxide (CHP), or benzoyl peroxide (BPO).

20. The thermoplastic prepreg of claim 17, wherein a weight ratio of the initiator to the monomer is 0.1%-2%, and a weight ratio of the monomer to the polymer ranges between 10:1 and 10:50.

21. The thermoplastic prepreg of claim 17, wherein the latent resin has the viscosity of 500,000-1,000,000 cps at 25° C.

22. The thermoplastic prepreg of claim 1, further comprising a filler for improving at least one of flame-retardance, UV resistance, and yellowing resistance.
